(19) United States
(12) Patent Application Publication
(10) Pub. No.: US 2021/0354658 A1
(43) Pub. Date: Nov. 18, 2021

(54) PROTOCOL FOR TOUCHLESS TRANSACTIONS AND COMMUNICATIONS

(71) Applicant: ULFBERHT LABS CORP., Jersey City, NJ (US)

(72) Inventors: MENISH GUPTA, Jersey City, NJ (US); RICHARD D. ARTURO, Medford, NJ (US); SAI PAVAN KUMAR CHITTI, Jersey City, NJ (US); JOSE ESCOLANO-CARRASCO, Brooklyn, NY (US); ANKUR MALIK, Jersey City, NJ (US)

(21) Appl. No.: 17/318,942

(22) Filed: May 12, 2021

Related U.S. Application Data
(60) Provisional application No. 63/025,889, filed on May 15, 2020.

(51) Int. Cl. B60R 25/01; G06Q 10/08; G05B 13/02; G06F 16/53; G06K 9/62; G06K 9/46

(52) U.S. Cl. CPC B60R 25/01; G06Q 10/083; G05B 13/0265; G06F 16/53; G06K 2209/23; G06K 9/46; G06K 9/6202; G06K 2209/15; G06K 9/6256

(57) ABSTRACT

Systems and method are provided for facilitating contactless delivery of a tangible good by a delivering party to an ordering party, comprising: receiving scanning data from a first computing device associated with the delivering party, the scanning data comprising a digital image of a vehicle license plate of a target device of the ordering party; determining a vehicle registration plate number of the vehicle license plate of the target device in the digital image; identifying a user account identification value associated in a datastore with the vehicle registration plate number; based on the identified user account identification value, determining an order of the tangible good associated in a datastore with the user account identification value and transmitting order information about the order including an identifier of the tangible good to the first computing device, thereby causing a display of the order information in a graphical user interface at the first computing device; transmitting a verification request to a second computing device, the second computing device associated in a datastore with the user account identification value, the verification request causing a display of a graphical user interface prompt at the second computing device to accept communications from the delivering party; based on receiving an affirmative response to the verification request from the second computing device, forwarding a message received from the first computing device to the second computing device, the message pertaining to effectuating contactless delivery by the delivering party of the tangible good to the ordering party.

### BENEFIT CLAIM

This application claims the benefit under 35 U.S.C. § 119(e) of provisional application 63/025,889, filed May 15, 2020, the entire disclosure of which is hereby incorporated by reference for all purposes as if fully set forth herein.

### FIELD OF THE DISCLOSURE

One technical field of the present disclosure is computer-implemented communication and transaction protocols. Yet another technical field is computer-implemented machine learning algorithms.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The delivery of goods from one party to another has involved face-to-face, personal interaction for hundreds of years. For example, in some cases, a first party must interact directly with a second party to complete an order for tangible goods and/or services. If the first party and the second party are operating in a hazardous or potentially adverse environment, the first party or the second party may desire to minimize points of contact with the other party. For example, if the geographic area where a transaction between a first party and a second party is taking place is known as a high crime or remote area, the first party may desire to stay in their vehicle while the transaction is completed. As another example, a party may desire to minimize points of contact with another party so as to prevent the transmission of disease. As another example, a first party may simply be uncomfortable with directly dealing with an unknown second party for a variety of additional reasons.

In such situations, various processes exist to assist a first party and a second party with completing transactions. For example, curbside pickup allows a customer to place an order with a merchant, drive to a pickup location, park a vehicle at the pickup location, and wait while a merchant agent delivers the order to the vehicle. Curbside pickup is successful at negating several points of contact with a customer, effectively reducing customer and merchant risk of exposure to external threats.

However, processes such as curbside pickup still expose parties of a transaction to various external threats. For example, when a customer arrives at a pickup location, the customer must interact and communicate with merchant employees to complete the pickup of an order. A customer is usually required to communicate with a merchant to direct delivery of the order to a vehicle compartment, complete payment for the order, and physically sign a receipt. Such interactions place the customer and merchant at risk of contracting disease and expose the customer and merchant to other external threats.

Currently, there is no non-intrusive, ad-hoc way for a party to communicate and interact with another party that minimizes exposure and points of contact. Computer-implemented techniques are desired to facilitate real time touchless communications and transactions.

### SUMMARY

The appended claims may serve as a summary of the invention.

### BRIEF DESCRIPTION OF THE DRAWINGS

FIG. 1 illustrates an example computer system, according to an embodiment.

FIG. 2 illustrates a flow chart of an example flow diagram of an example process, according to an embodiment.

FIG. 3 illustrates an example of a protocol for touchless transactions and communications, according to an embodiment.

FIG. 4 illustrates an example graphical user interface (GUI) that is programmed to display authorized vehicle information associated with a user account.

FIG. 5 illustrates an example GUI that is programmed to allow the editing of authorized vehicle information associated with a user account.

FIG. 6 illustrates an example GUI that is programmed to obtain scanning data from a target device.

FIG. 7 illustrates an example GUI that is programmed to display user account data that is identified based on scanning data obtained from a target device.

FIG. 8 illustrates an example GUI that is programmed to display order data.

FIG. 9 illustrates an example GUI that is programmed to display detailed order data.

FIG. 10 illustrates an example GUI that is programmed to display message data.

FIG. 11 illustrates an example computer system, according to an embodiment.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

1. OVERVIEW

2. EXAMPLE COMPUTER SYSTEM IMPLEMENTATION

3. EXAMPLE FUNCTIONAL IMPLEMENTATION

4. EXAMPLE PROTOCOL IMPLEMENTATION

5. EXAMPLE GRAPHICAL USER INTERFACE IMPLEMENTATION

6. HARDWARE OVERVIEW

7. OTHER ASPECTS OF DISCLOSURE

1. Overview

Systems and methods are provided to facilitate a protocol for touchless transactions and communications. Scanning data is received from a first computing device associated with a delivering party, the scanning data comprising a digital image of a vehicle license plate of a target device of the ordering party. Using a first trained machine learning model, a vehicle registration plate number of the vehicle license plate of a target device in the digital image is determined. A user account identification value associated in a datastore with the vehicle registration plate number is identified. Based on the identified user account identification value, an order of a tangible good associated in a datastore with the user account identification value is determined and order information about the order including an identifier of the tangible good is transmitted to the first computing device, thereby causing a display of the order information in a graphical user interface at the first computing device. A verification request is transmitted to a second computing device, the second computing device associated in a datastore with the user account identification value, the verification request causing a display of a graphical user interface prompt at the second computing device to accept communications from the delivering party. Based on receiving an affirmative response to the verification request from the second computing device, a message received from the first computing device is forwarded to the second computing device, the message pertaining to effectuating contactless delivery by the delivering party of the tangible good to the ordering party.

In some embodiments, as a security checkpoint, features can be extracted from digital images of the target device and scanning data. The features can be compared to determine if the features extracted from the scanning data match the features from the target device data to a certain threshold.

Techniques discussed herein facilitate touchless communications and transactions between computing devices. Techniques discussed herein are effective as negating points of contact between consumers and merchants and reduce exposure risk of a consumer or merchant to external threats. Techniques discussed herein provide enhanced security against fraud by using machine learning based processes to first identify customer devices and then verify customer devices by extracting features from images of customer devices and matching features between images to a certain threshold. Additionally, techniques discussed herein provide processes to effectively obfuscate contact information associated with consumers such that a merchant can ad-hoc communicate with a consumer without any consumer contact information being revealed to the merchant. Furthermore, techniques discussed herein provide processes that allow a consumer to control a communication channel by accepting or denying ad-hoc communications from merchants or other consumers. The techniques discussed herein can permit processing data with fewer CPU cycles and less memory needed. Further, the techniques herein provide flexibility for touchless communications and transactions to be integrated in a variety of application contexts.

2. Example Computer System Implementation

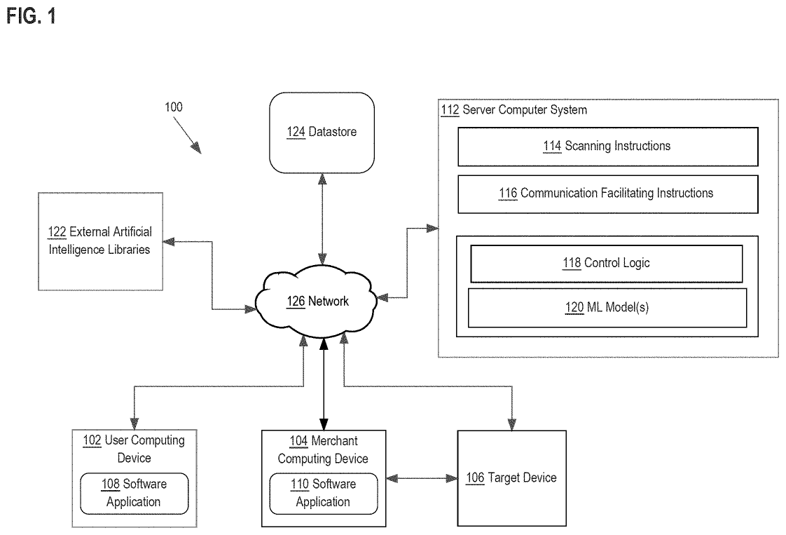

FIG. 1 illustrates an example networked computer system with which various implementations may be practiced. FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of how to accomplish contactless delivery of tangible goods to a party with automatic detection of the arrival of the party and automatic determination of the correct order or goods without communication initiated by the receiving party. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

FIG. 1 is shown in simplified, schematic format for purposes of illustrating a clear example and other implementations may include more, fewer, or different elements. System 100 comprises various entities and devices which may be used to practice an implementation. Network 126 is a network entity which facilitates communication between entities depicted in FIG. 1. Connection to network 126 is show by double-sided arrows between a connecting entity and network 126. Network 126 may be any electronic communication medium or hub which facilitates communications between two or more entities, including but not limited to an internet, an intranet, a local area connection, a cloud-based connection, a wireless connection, a radio connection, a physical electronic bus, or any other medium over which digital and electronic information may be sent and received.

Server computer system 112 is connected to network 126 and is an entity which facilitates a protocol for touchless transactions and communications between user computing device 102, merchant computing device 104, and target device 106. Server computer system 112 may be any hardware, software, virtual machine, or general-purpose entity capable of performing the processes discussed herein. In various implementations, the server computer system 112 executes scanning instructions 114 and communication facilitating instructions 116, the functions of which are described in other sections herein. The server computer system 112 may also execute additional code, such as code for generating and transmitting requests to user computing device 102 and datastore 124.

The server computer system 112 is programmed or configured to process functions for the creation and management of a plurality of different user accounts and merchant accounts, consisting of a set of credentials that may be used to access the system using one of the computing devices 102, 104. Each account comprises a record in a datastore 124 that associates a unique handle, identifier or name; a screen name or display name; credentials such as an e-mail address and password; and other metadata relating to an account. For example, a user account may comprise one or more data records that include a user identifier, a first and last name, a customer address, a phone number, an email address, authorized vehicle information comprising one or more vehicle registration plate numbers, payment information, order information, and target device data that identifies any target devices that are associated with the respective user account. A merchant account may comprise one or more data records that include a merchant identifier, a merchant address, a phone number, a web site, one or more locations, a set of authorized users associated with the merchant, and order information. Data relating to accounts may be stored in datastore 124. Datastore 124 may be any number of individual or linked storage devices or mediums which allow the storage of digital data, as discussed herein.

The scanning instructions 114 may be programmed or configured to receive scanning data and analyze the scanning data to identify vehicle identification data based on the scanning data. For example, the scanning instructions 114 may include features to access or receive information from the datastore 124 and/or merchant computing device 104. The scanning instructions 114 may also access external data sources and transmit or receive data to and from the communication facilitating instructions 116. The scanning instructions 114 may also be used for implementing aspects of the flow diagrams that are further described herein.

In one embodiment, the scanning instructions 114 may be programmed or configured to interface with ML models 120 and/or control logic 118 to identify vehicle identification data based on the scanning data. For example, scanning instructions 114 may transmit scanning data to control logic 118 and/or ML model(s) 120. Control logic 118 and/or ML models 120 generate vehicle identification data based on the scanning data. For example, by using scanning data comprising an image of a vehicle as input to a ML model, the ML model outputs vehicle identification data comprising a vehicle license (tag) number or a vehicle registration number. Scanning operations also could include reading a radio-frequency identification (RFID) tag that is affixed to a vehicle, or electrically exciting and reading other kinds of tags, scanning and reading active or passive devices such as road toll payment tags affixed to vehicles. Other embodiments may use different internal organizational arrangements to implement functionally equivalent computer operations.

The control logic 118 may be programmed or configured to interface with external artificial intelligence libraries 122 to obtain ML model(s) 120. In one embodiment, the control logic 118 may be programmed or configured to interface with external artificial intelligence libraries 122 to train ML model(s) 120. In an embodiment, external artificial intelligence libraries 122 implement neural network functions, classifier functions, natural learning processing, or other machine learning functions and may be imported, statically or dynamically linked, called or programmatically integrated into or coupled to the ML model 120 using other means. In an embodiment, to external artificial intelligence libraries 122 comprise the TensorFlow system, which is publicly available under open-source licensing.

The communication facilitating instructions 116 may be programmed or configured to manage communications between user computing device 102, merchant computing device 104, and target device 106. For example, the communication facilitating instructions 116 may be programmed or configured to receive a request to initiate and execute a protocol for touchless transactions and communications from user computing device 102 or merchant computing device 104. The communication facilitating instructions 116 may be programmed or configured match vehicle identification data to user account data. The communication facilitating instructions 116 may be programmed or configured to transmit a verification request to user computing device 102 or merchant computing device 104. The communication facilitating instructions 116 may be programmed or configured to receive a response to a verification request from user computing device 102 or merchant computing device 104, and take an action based on the response to the verification request. An action may comprise opening a secure communication channel between user computing device 102 and merchant computing device 104 or restricting communication between user computing device 102 and merchant computing device 104. The communication facilitating instructions 116 may be programmed or configured to facilitate the exchange of messages or voice communications between user computing device 102 and merchant computing device 104. The communication facilitating instructions 116 may be programmed or configured to receive commands or requests to execute an action, and in response, transmit the commands or requests to target computing device 106 for execution. In some embodiments, executing an action comprises opening or unlocking a compartment of a target device, such as a vehicle. The communication facilitating instructions 116 may also be used for implementing aspects of the flow diagrams that are further described herein.

Computer executable instructions described herein may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. In another embodiment, the programmed instructions also may represent one or more files or projects of source code that are digitally stored in a mass storage device such as non-volatile RAM or disk storage, in the systems of FIG. 1 or a separate repository system, which when compiled or interpreted cause generating executable instructions which when executed cause the computer to perform the functions or operations that are described herein with reference to those instructions. In other words, the drawing figure may represent the manner in which programmers or software developers organize and arrange source code for later compilation into an executable, or interpretation into bytecode or the equivalent, for execution by the server computer system 112.

User computing device 102 is a user account device/entity which allows an individual user to interact with software application 108 installed on the user computing device 102. User computing device 102 may be any device, such as a mobile computing device, capable of connection to network 126 through any method described herein. User computing device 102 may comprise various programs, modules, or software applications, including operating system and software application 108. The user computing device 102 may receive actions comprising instructions, requests, notifications, and/or recommendations to execute or display from server computer system 112.

Merchant computing device 104 is a user account device/entity which allows an individual user such as merchants or merchant employees to interact with software application 110 installed on the merchant computing device 104. A merchant computing device 104 may be any device, such as a mobile computing device, capable of connection to network 126 through any method described herein. Merchant computing device 104 may comprise various programs, modules, or software applications, including operating system and software application 110. The merchant computing device 104 may receive actions comprising instructions, requests, notifications, and/or recommendations to execute or display from server computer system 112. The merchant computing device 104 may also transmit data, such as data retrieved from target device 106 to server computer system 112.

In one embodiment, merchant computing device 104 may comprise any type of computing device that allows the scanning or photographing of target device 106. In one embodiment, target device 106 may comprise a vehicle that includes a vehicle registration plate. In one embodiment, target device 106 may comprise a vehicle that includes RFID tag, QR code or other similar technology. Any contactless smart card that works though other protocols may be used. The target device 106 may be used to allow the admin computing device 104 to extract scanning data, such as an image or photograph of the target device 106.

In some embodiments, target device 106 may include capability of connection to network 126 through any method described herein. Target device 106 may comprise various programs, modules, or software applications, including an operating system and software applications. The target device 106 may receive actions comprising instructions, requests, notifications, and/or commands to execute from server computer system 112. The target device 106 may execute any received actions of commands, as further discussed herein. The merchant computing device 104 may also transmit data to server computer system 112.

Any of the components of the system 100 and associated architecture may include alternate and/or additional hardware, software, or firmware components beyond those described or depicted without departing from the scope of the disclosure. For example, hardware, software, or firmware components depicted or described as forming part of any of the illustrative components of the system 100, and the associated functionality that such components support, are merely illustrative and that some components may not be present or additional components may be provided in various embodiments. While various program modules have been depicted and described with respect to various illustrative components of the system 100, the functionality described as being supported by the program modules may be enabled by any combination of hardware, software, and/or firmware. Each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. The functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

The system 100 is one example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system 100, or additional functionality.

3. Example Functional Implementation

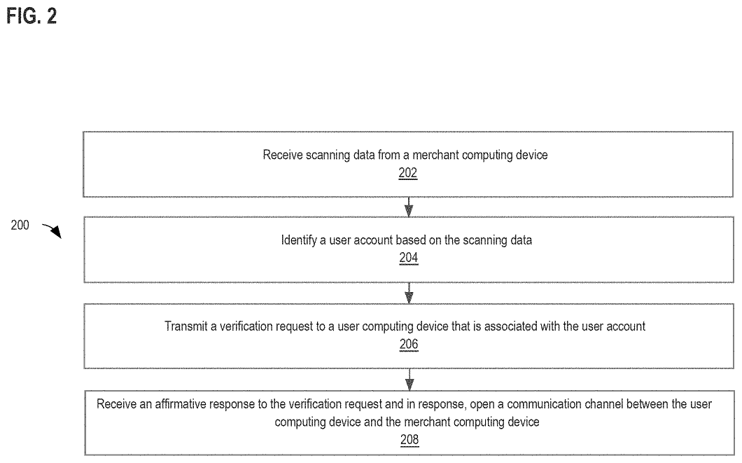

FIG. 2 shows an example flowchart of a method for a protocol for touchless transactions and communications, according to an embodiment.

Although the steps in FIG. 2 are shown in one example order, the steps of FIG. 2 may be performed in any order and are not limited to the order shown in FIG. 2. Additionally, some steps may be optional, may be performed multiple times, or may be performed by different components. All steps, operations, and functions of a flow diagram that are described herein are intended to indicate operations that are performed using programming in a special-purpose computer or general-purpose computer, in various embodiments. Each flow diagram and block diagram is presented at the same level of detail that persons skilled in the applicable technical fields use to communicate with one another about plans, specifications, algorithms, and data structures as a basis for programming implementations to solve the applicable technical problems, while also applying their accumulated knowledge and skill of computer architecture, programming, and engineering techniques. Each flow diagram in this disclosure provides a guide, plan, or specification of an algorithm for programming a computer to execute the functions that are described.

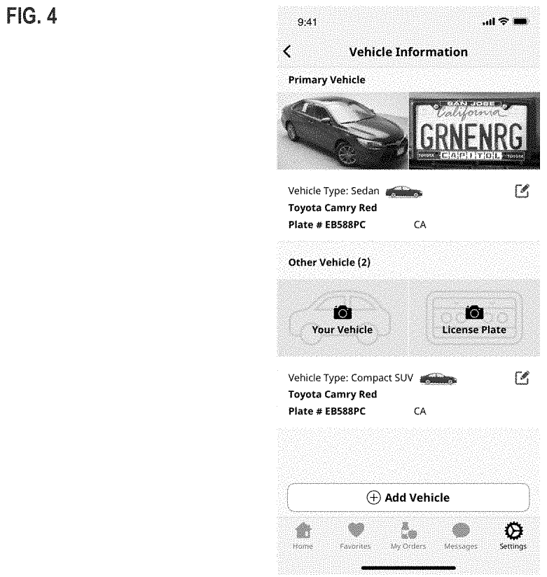

In step 202, scanning data is received. For example, merchant computing device 104 scans or photographs target device 106 to generate or create scanning data. Merchant computing device 104 transmits the scanning data to server computer system 112 via network 126. In some embodiments, scanning data comprises an image of target device 106 that includes a vehicle registration plate number. In other embodiments, scanning data comprises an identification value of target device 106. FIG. 4 illustrates an example scanning data image. Image 400 depicts an image of a target device as a vehicle 402. Image 400 includes vehicle registration plate number 404.

In step 204, a user account is identified based on the scanning data. For example, server computer system 112 analyzes scanning data to identify a vehicle registration plate number. The vehicle registration plate number is compared to a plurality of vehicle registration plate numbers that are associated with user accounts and stored in datastore 124. When a match is found between the vehicle registration plate number from the scanning data and a vehicle registration plate number from the plurality of vehicle registration plate numbers stored in datastore 124, the user account associated with the matching vehicle registration plate is identified as a matching user account.

In some embodiments, the scanning data received in step 202 is used as input to one or more ML model(s) 120 to extract a vehicle registration plate number from the scanning data.

In one embodiment, training ML models 120 training ML models 120 to extract a vehicle registration plate number from the scanning data can be accomplished using a training dataset comprising a plurality of images of vehicle registration plates and corresponding vehicle registration plate number. A supervised machine learning model can be trained using the training dataset to extract vehicle registration plate numbers from images of vehicle registration plates.

In some embodiments, training ML models 120 to extract a vehicle registration plate number from the scanning data can be accomplished using any applicable method or toolkit. For example, technical details and examples of extracting a vehicle registration plate number from an image are provided by and herein incorporated by reference: Open ALPR by Rekor Systems Inc, Plate Recognizer by ParkPow, Inc., Intellivision by Nortek Control LLC.

In some embodiments, target device data is stored in association with a user account. For example, target device data associated with a particular user account may comprise one or more images of a target device 106, such as an image of a vehicle, that is included in the particular user account's authorized vehicle information.

Target device data can be analyzed by ML model(s) 120 to identify features of the target device such as: a color of a target device 106, a make of the target device 106, a model of the target device 106, a type of the target device 106 any scratches in the target device 106, any dents in target device, a region of the target device 106.

In some embodiments, training ML models 120 to extract features of the target device from the target device data can be accomplished using any applicable method or toolkit. For example, technical details and examples of extracting features from an image of a vehicle are provided by and herein incorporated by reference: Open ALPR by Rekor Systems Inc, Plate Recognizer by ParkPow, Inc., Intellivision by Nortek Control LLC.

In one embodiment, training ML models 120 training ML models 120 to extract features of the target device from the target device data can be accomplished using a training dataset comprising a plurality of images of vehicles and/or vehicle registration plates and corresponding features. A supervised machine learning model can be trained using the training dataset to extract features such as color, make, model, type, scratches, dents, region/state from images of vehicles or vehicle registration plates.

In some embodiments, features such as color, make, model, type, scratches, dents, region can be extracted from the scanning data using similar techniques discussed above with respect to the target device data.

In some embodiments, additional features can be extracted based on metadata that is associated with images included in the scanning data or target device data. For example, embedded features can be extracted from the metadata of an image from the scanning data or target device data such as GPS coordinates, device info, time the image was taken, date the image was taken, identity of person who captured the image.

In some embodiments, once features have been extracted from the scanning data and the target device data, the features associated with the scanning data can be compared to the features associated with the target device data as a security measure. In one example, if the features of the target device data do not match the features from the scanning data to a certain threshold, flow 200 is terminated and no further steps will be taken. In some embodiments, if the features from target device data do not match the features from the scanning data to a certain threshold, an alert may be transmitted to the user computing device 102 that requests verification that the target device 106 from the scanning data is acceptable. A threshold may be configurable by an administrator. As an example, a threshold may be set to 60%, indicating that at least 60% of the features of target device data must match the corresponding features from the scanning data in order to pass the security checkpoint.

In some embodiments, if one particular feature from the target device data does not match the corresponding feature from the scanning data, such as a make or model of the target device, flow 200 may be terminated or an alert may be transmitted to the user computing device 102 that requests verification that the target device 106 from the scanning data is acceptable.

Extracting and comparing features from target device data and scanning data provides enhanced security against fraud by ensuring that various characteristics of a target device associated with a user account correctly match a target device that is scanned by a merchant.

In step 206, a verification request is transmitted to a user computer device that is associated with the user account. This step may be performed in response to identifying the user account in step 204. For example, in response to identifying a user account that is associated with the vehicle registration plate number, server computer system 112 identifies user computing device 102 that is associated with the user account. Alternatively, or additionally, server computer system 112 identifies a software application 108 that is associated with the user account. Server computer system 112 generates and transmits a verification request to user computing device 102 and/or software application 108.

In some embodiments, a verification request comprises a request to open a communication channel. For example, a verification request may comprise a request that causes a display of a prompt to accept further communications with a merchant, such as a merchant operating the merchant computing device 104.

In step 208, an affirmative response to the verification request is received. In response to receiving the affirmative response, a communication channel is opened between the user computing device and a merchant computing device. In some embodiments, a communication channel comprises communication data that indicates a logical connection between a particular merchant account and a particular user account. Communication data may be stored in datastore 124 and accessed by server computer system 112.

A communication channel allows a user account to communicate with a merchant account. For example, by using software application 108 associated with user computing device 102 102, a user account can send a message to a merchant using software application 110 associated with merchant computing device 104, or vice versa. As an example, when a communication channel is opened between a user account and a merchant account, the merchant account using software application 110 associated with merchant computing device 104 can send messages or voice communications in real time to the user account that are received by the user account using software application 108 associated with user computing device 102.

In some embodiments, server computing system 110 functions as a middleman between a user account and a merchant account. For example, server computing system 110 receives all messages that are transmitted from a merchant account associated with merchant computing device 104 and a user account associated user computing device 102. After receiving messages and before transmitting messages to the intended recipient, server computing system 110 determines whether a communication channel exists between the sender account and recipient account. If a communication channel exists, server computing system 110 transmits the received message to the intended recipient account. If a communication channel does not exist, server computing system 110 restricts the transmission of the received message to the intended recipient account, i.e., does not transmit the message.

By using the server computer system 112 as a middleman between user computing device 102 and merchant computing device 104, contact information associated with user accounts that are associated with the user computing device 102 are obfuscated. For example, by using the server computer system 112 to receive and transmit messages between user computing device 102 and merchant computing device 104, sensitive user account information such as phone number, address, payment information, etc. is never revealed to merchant computing device 104 while allowing a communication flow between such devices.

In other embodiments, server computing system 110 controls graphical user interface (GUI) functionality of software application 108 and software application 110 such that when a communication channel is not opened between a user account and merchant account, the interface functionality of the respective software application that allows a merchant account or user account to send messages to the other party is disabled on the respective computing devices or software applications of the user and merchant computing devices. In addition, server computing system 110 controls GUI functionality of software application 108 and software application 110 such that when a communication channel is opened between a user account and merchant account, the interface functionality that allows a merchant account or user account to send messages to the other party is enabled on the respective computing devices or software applications of the user and merchant computing devices.

In some embodiments, a negative response to the verification request is received. In this case, a communication channel is not opened between the user computing device and a merchant computing device.

In some embodiments, once a communication channel is opened between the user account associated with user computing device 102 and the merchant account associated with merchant computing device 104, in addition to sending messages, a user account or merchant account can send commands or actions to be executed by the target device 106. For example, the merchant account using merchant computing device 104 can send a command that causes an action to be executed on a target device 106 that is associated with the user account. In one embodiment, the command or action may comprise an “open compartment” command, that, when received by the target device 106, programmatically causes the unlocking or opening of a compartment, such as a trunk or door, of the target device 106. In one embodiment, the command or action may be forwarded directly to the target device 106. In another embodiment, the command or action may be forwarded to the user computing device 102, which can then communicate directly with the target device 106 to cause the command or action to be executed by the target device 106.

In some embodiments, receipt data is received from merchant computing device 104. In one embodiment, receipt data comprises an image or photograph. The image or photograph depicts goods associated with a transaction between user computing device 102 and merchant computing device 104 that were successfully placed in a compartment associated with target device 106. For example, receipt data may comprise an image of a food order placed in a trunk of a vehicle and metadata such as time and location that the image was taken and/or uploaded. The receipt data may be stored in datastore 124 in association with a transaction between merchant computing device 104 and use computing device 102.

4. Example Protocol Implementation

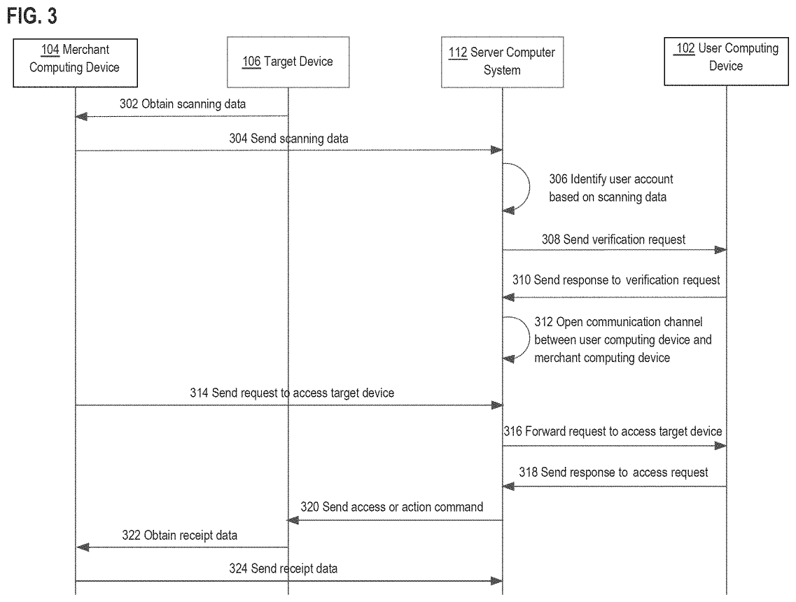

FIG. 3 illustrates an example of a protocol for touchless transactions and communications accordance with an embodiment. In FIG. 3, user computing device 102, user merchant computing device 104, target device 106, and server computer system 112 are shown.

To begin, at step 302 the merchant computing device 104 obtains scanning data from target device 106. The scanning data may include an image, photograph, video, or any identification value. Once the scanning data is obtained in step 302, the merchant computing device 104 sends the scanning data to server computer system 112.

In some embodiments, before step 302, user computing device 102 may initiate a communication with user merchant computing device 104. By initiating the communication, server computer system 112 assigns user computing device 102 a queue number in a queue of users waiting for service. User computing device 102 waits in the queue until the merchant computing device 104 initiates step 302. In still other embodiments, the process of FIG. 3 cannot advance unless the user computing device 102 initiates a communication.

At 306, server computer system 112 identifies a user account based on the scanning data. Step 306 may include server computer system 112 using scanning data as input to a trained machine learning model to determine a vehicle registration plate number, tag number or other identifier. The vehicle registration plate number is compared to data records stored in datastore 124 (not shown) to identify the user account that is associated with the vehicle registration plate number.

At step 308, a verification request is sent to the user computing device 102 that is associated with the user account identified in step 306. The verification request is sent to user computing device 102 in response to identifying the user account based on the scanning data. It may also be determined that a unique identifier of the user computing device 102 is associated with the user account. The unique identifier may be used to direct the verification request to user computing device 102. The verification request may comprise a request to open a communication channel. For example, the verification request may comprise a request that causes a display of a prompt at user computing device 102 to accept communications from the merchant computing device 104.

At step 310, user computing device 102 sends a response to the verification request to the server computer system 112. If the response is an affirmative response, i.e., an acceptance of the verification request, then in response, at step 312 server computer system 112 opens a communication channel between the user computing device 102 and merchant computing device 104. If the response is a negative response, i.e., a decline of the verification request, in response, at server computer system 112 does not open a communication channel between the user computing device 102 and merchant computing device 104. In one embodiment, by opening a communication channel, server computer system 112 allows user computing device 102 to communicate with merchant computing device 104 and vice versa. For example, using the communication channel, merchant computing device 104 can send messages through server computer system 112 to user computing device 102. User computing device 102 can send messages or voice communications through server computer system 112 to merchant computing device 104. In these embodiments, the use of a verification request, followed by a confirming response from the user computing device 102, enables the user computing device to exercise control over a transaction and to provide other information or interact with a merchant or other party only when the user computing device or its user determine(s) that interaction is appropriate.

In some embodiments, once the communication channel is opened between the user computing device 102 and merchant computing device 104, the merchant computing device 104, a payment transaction is initiated. In the case of a payment transaction with a credit card, payment may be offered by user computing device 102 to merchant computing device 104 using near field communication (NFC). In response to receiving credit card information, merchant computing device 104 forwards the credit card information to server computing system 110 to complete the payment. Server computing system 110 then transmits a receipt prompt to the user computing device 102, where a user operating the user computing device 102 can sign the receipt to the payment transaction. Server computing system 110 receives the signed receipt from user computing device 102 and stores the receipt data in datastore 124. In the case of a payment transaction with a debit cart, a message will be sent to the user computing device 102 as a prompt to enter a debit card pin number in the app to validate the transaction.

In some embodiments, once the communication channel is opened between the user computing device 102 and merchant computing device 104, user computing device 102 or merchant computing device 104 can send a request to server computing system 110 to close the communication channel. In response to such a request, server computing system 110 closes the communication channel and no further communications can be made between merchant computing device 104 and user computing device 102 without reinitiating the verification process.

At step 314, once the communication channel is opened between the user computing device 102 and merchant computing device 104, the merchant computing device 104 sends a request to access target device 106. In some embodiments, the request to access target device 106 may be generic and may specify that the merchant computing device 104 desires to access a target device 106 that is associated with user computing device 102.

When server computing system 110 receives the request to access target device 106, at step 316 server computing system 110 forwards the request to access the target device 106 to the user computing device 102.

At step 318, a response to the request to access target device 106 is sent to the server computer system 112. If the response is an affirmative response, i.e. an acceptance, in response, at step 320 server computer system 112 send an access or action command to the target device 106. If the response is a negative response, i.e. a decline, in response, at server computer system 112 does not send a command to the target device 106.

In some embodiments, upon receiving the request to access target device 106, server computing system 110 sends and action or access command directly to the target device 106 without receiving approval from the user computing device 102. Upon receiving the action or access command, the target device 106 executes the command.

In some embodiments, the command may cause a compartment associated with target device 106 to be opened or unlocked.

At step 322, merchant computing device 104 obtains receipt data from target device 106. In one embodiment, receipt data comprises an image or photograph and associated metadata. The image or photograph depicts goods associated with a transaction between user computing device 102 and merchant computing device 104 successfully placed in a compartment associated with target device 106. For example, receipt data may comprise an image of a food order placed in a trunk of a vehicle and metadata such as time and location that the image was taken and/or uploaded.

At step 324, the receipt data is sent to server computing system 110 where is it stored in a datastore 124 (not shown). The receipt data may be stored in association with a transaction between merchant computing device 104 and use computing device 102.

In some embodiments, a user account may authorize another account to act on the user account's behalf. For example, a user account may authorize a courier account to deliver an order placed by the user account to the user account's address. In this scenario, an order is initially placed between a user account and merchant account. A user account may authorize a particular courier account to pick up and deliver the order. The courier account may be associated with its own authorized vehicle information and/or target device information, similar to a user account. When the courier account arrives to pickup the order at the pickup location, the merchant account obtains scanning data from the target device, e.g., vehicle, used by the courier account. The scanning data is sent to the server computer system 112. Server computer system 112 determines that the scanning data is associated with a courier account, and that the courier account that has been authorized by a user account for a particular order. In response, a verification request is sent to the courier account so that a communication channel can be opened between the courier account and merchant account. Once a communication channel has been opened between the courier account and merchant account, messages and commands can be sent by the merchant account to the courier account and any target devices that are associated with the courier account. Once it is confirmed that the courier account has delivered the order to the address associated with the user account, the authorization to deliver on behalf of the user account may be removed from association with the user account.

Techniques discussed herein facilitate touchless communications and transactions between computing devices. Techniques discussed herein are effective as negating points of contact between consumers and merchants and reduce exposure risk of a consumer or merchant to external threats. Techniques discussed herein provide enhanced security against fraud by using machine learning based processes to first identify customer devices and then verify customer devices by extracting features from images of customer devices and matching features between images to a certain threshold. Additionally, techniques discussed herein provide processes to effectively obfuscate contact information associated with consumers such that a merchant can ad-hoc communicate with a consumer without any consumer contact information being revealed to the merchant. Furthermore, techniques discussed herein provide processes that allow a consumer to control a communication channel by accepting or denying ad-hoc communications from merchants or other consumers. The techniques discussed herein can permit processing data with fewer CPU cycles and less memory needed. Further, the techniques herein provide flexibility for touchless communications and transactions to be integrated in a variety of application contexts.

The description of certain embodiments has referred, for purposes of clearly illustrating examples, to merchants, customers or consumers. However, embodiments are not limited to parties with a merchant-customer relationship, but can be implemented in relation to any two parties. Furthermore, references to labels of persons such as merchants, customers or consumers are provided merely for clarity, but embodiments are intended to operate purely on a technical basis in which a distributed computer system has multiple computers that interoperate using digital data to represent accounts or records for the persons that are referenced.

5. Example Graphical User Interface Implementation

FIG. 4 illustrates an example graphical user interface (GUI) that is programmed to display authorized vehicle information associated with a user account. For example, a user that is logged into a user account on software application 108 may navigate to the ‘Settings’ tab to view authorized vehicle information associated with the user account. Functionality of the page may include viewing existing authorized vehicle information and/or the ability to add authorized vehicle information. A user may select ‘Add Vehicle’ to add target device data including images and other authorized vehicle information for a new vehicle. A user may select an edit button to edit authorized vehicle information that is associated with a previously entered data record.

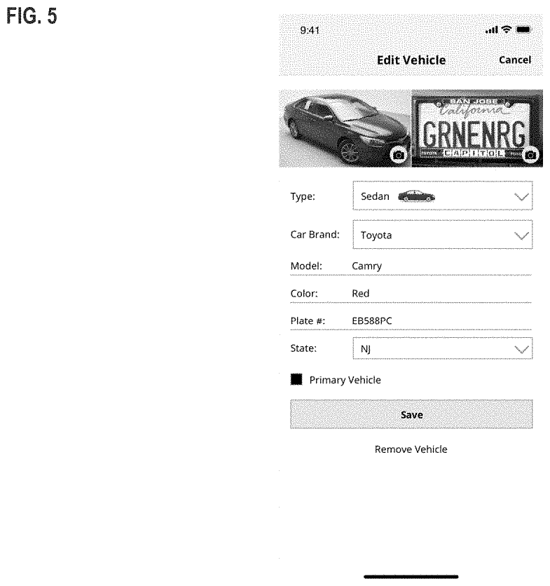

FIG. 5 illustrates an example GUI that is programmed to edit authorized vehicle information associated with a user account. For example, a user that is logged into a user account on software application 108 may select an edit button to edit target device data authorized vehicle information that is associated with a previously entered data record, such as discussed with respect to FIG. 4. The GUI shown in FIG. 5 allows a user to select and enter target device data and authorized vehicle information including a ‘Type’ of vehicle, a ‘Car Brand’, a ‘Model’, a ‘Color’, a vehicle registration plate number, i.e., ‘Plate #’, and a ‘State’. Such information may be saved in associated with a user account in datastore 124.

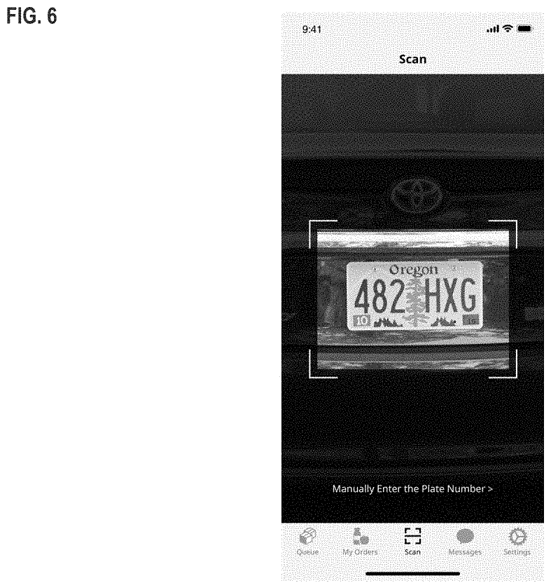

FIG. 6 illustrates an example GUI that is programmed to obtain scanning data from a target device. For example, a merchant that is logged into a merchant account on software application 110 may navigate to the ‘Scan’ tab to obtain scanning data from a target device. Functionality of the page may include allowing a merchant using software application 110 to take an image or photograph of a target device, such as a vehicle. Software application 110 may include functionality that recognizes a vehicle registration plate number in real time and generates a box enclosure around the vehicle registration plate number, as shown in FIG. 6. Software application 110 may include functionality that allows a merchant using software application 110 to manually enter a vehicle registrations plate number.

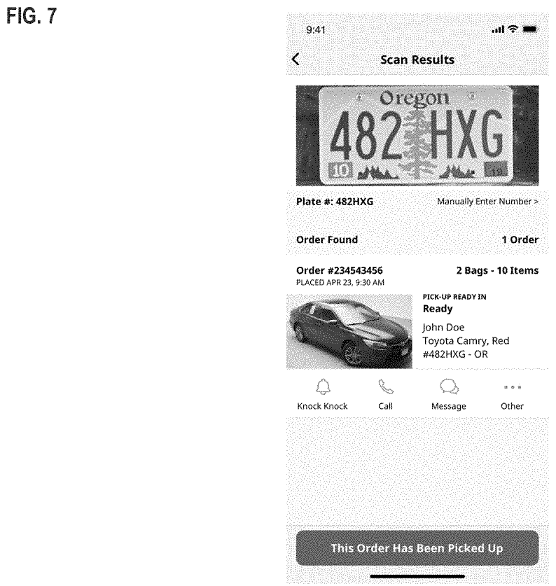

FIG. 7 illustrates an example GUI that is programmed to display user account data that is identified based on scanning data obtained from a target device. For example, a merchant that is logged into a merchant account on software application 110 may obtain scanning data using a GUI such as shown in FIG. 6. Software application 110 executing on merchant computing device 104 transmits the obtained scanning data to server computer system 112 where server computing system 112 programmatically identifies a vehicle registration plate number from the scanning data and matches the identified vehicle registration plate number to a user account. Data associated with the user account, such as any orders, target device information are displayed in FIG. 7.

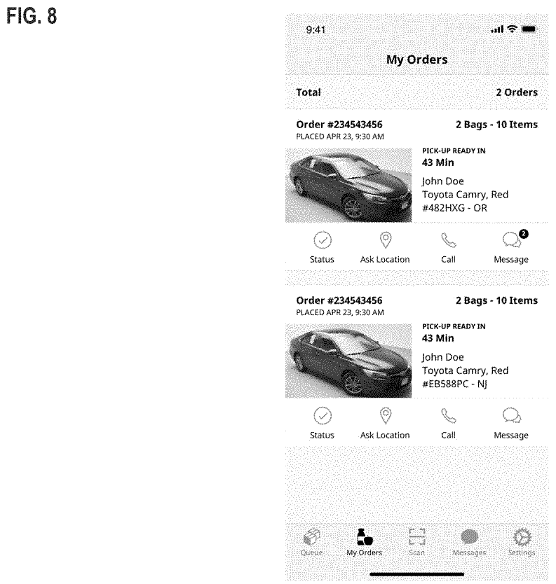

FIG. 8 illustrates an example GUI that is programmed to display order data. For example, a merchant that is logged into a merchant account on software application 110 may navigate to the ‘My Orders’ tab to display all orders that are placed with a particular merchant. Orders may be assigned to a particular merchant account and displayed with associated order information as shown in FIG. 8.

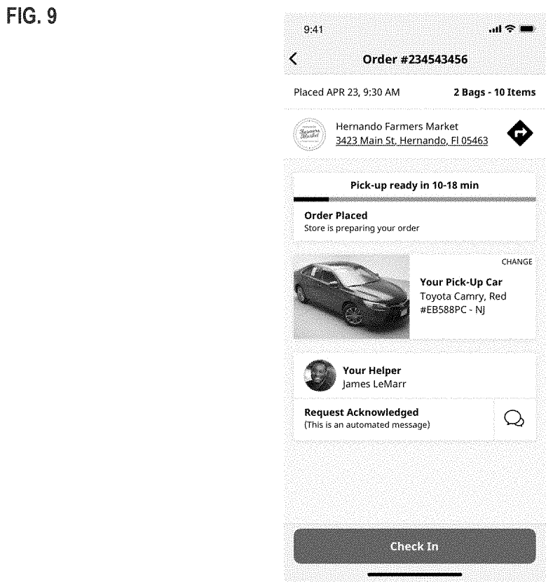

FIG. 9 illustrates an example GUI that is programmed to display detail order data. For example, a user that is logged into a user account on software application 108 may select an order that was placed by the respective user account. In response, detailed order information as shown in FIG. 9 is displayed. Detailed order information may include the address of the pickup location, estimated pick up time, target device information, merchant account information such as a particular merchant account assigned to the order, and any messages exchanged between the user account and merchant account.

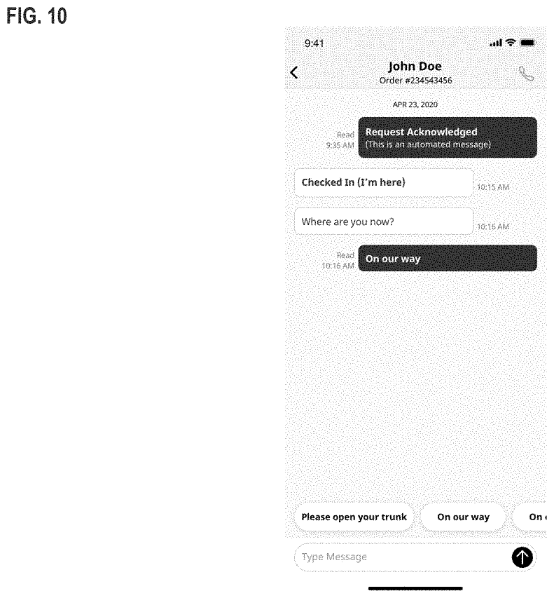

FIG. 10 illustrates an example GUI that is programmed to display message data. For example, a user that is logged into a user account on software application 108 may send messages to a merchant logged into a merchant account on software application 110. In one embodiment, the merchant account may send a verification request, as discussed with respect to FIG. 2 and FIG. 3. The user account may accept the verification request, shown as “Request Acknowledged” in FIG. 10. Once the verification request is accepted or acknowledged, a communication channel is opened that allows the user account and merchant account to send messages to the other party. For example, the user account in FIG. 10 transmits the messages “Checked In (I'm here)” and “Where are you now?” to the merchant account. The merchant account transmits the message “On our way” in response to the user account's messages. Using the interface shown in FIG. 10, a user account or merchant account can generate other messages for transmission and may also generate commands for transmission to the other party. For example, by selecting the command “Please open your trunk” a command may be sent to a target device associated with the user account that causes the trunk to be opened.

6. Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

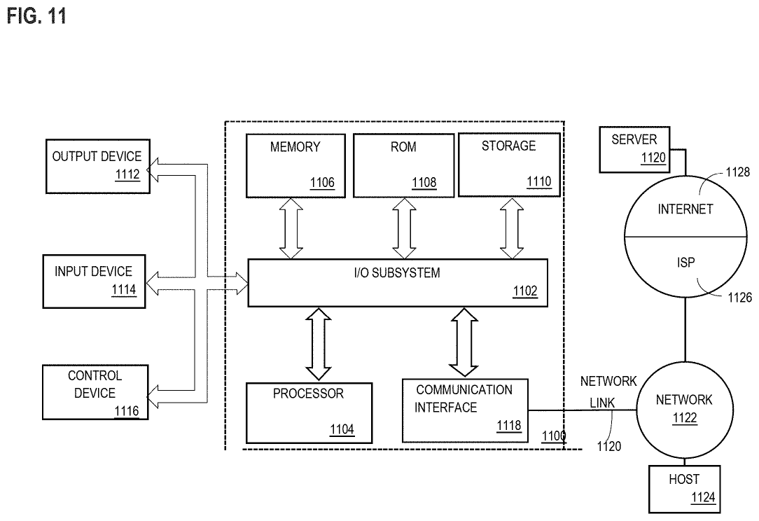

FIG. 11 is a block diagram that illustrates an example computer system with which an embodiment may be implemented. In the example of FIG. 11, a computer system 1100 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 1100 includes an input/output (I/O) subsystem 1102 which may include a bus and/or other communication mechanism(s) for communicating information and/or instructions between the components of the computer system 1100 over electronic signal paths. The I/O subsystem 1102 may include an I/O controller, a memory controller and at least one I/O port. The electronic signal paths are represented schematically in the drawings, for example as lines, unidirectional arrows, or bidirectional arrows.

At least one hardware processor 1104 is coupled to I/O subsystem 1102 for processing information and instructions. Hardware processor 1104 may include, for example, a general-purpose microprocessor or microcontroller and/or a special-purpose microprocessor such as an embedded system or a graphics processing unit (GPU) or a digital signal processor or ARM processor. Processor 1104 may comprise an integrated arithmetic logic unit (ALU) or may be coupled to a separate ALU.

Computer system 1100 includes one or more units of memory 1106, such as a main memory, which is coupled to I/O subsystem 1102 for electronically digitally storing data and instructions to be executed by processor 1104. Memory 1106 may include volatile memory such as various forms of random-access memory (RAM) or other dynamic storage device. Memory 1106 also may be used for storing temporary variables or other intermediate information during execution of instructions to be executed by processor 1104. Such instructions, when stored in non-transitory computer-readable storage media accessible to processor 1104, can render computer system 1100 into a special-purpose machine that is customized to perform the operations specified in the instructions.

Computer system 1100 further includes non-volatile memory such as read only memory (ROM) 1108 or other static storage device coupled to I/O subsystem 1102 for storing information and instructions for processor 1104. The ROM 1108 may include various forms of programmable ROM (PROM) such as erasable PROM (EPROM) or electrically erasable PROM (EEPROM). A unit of persistent storage 1110 may include various forms of non-volatile RAM (NVRAM), such as FLASH memory, or solid-state storage, magnetic disk or optical disk such as CD-ROM or DVD-ROM, and may be coupled to I/O subsystem 1102 for storing information and instructions. Storage 1110 is an example of a non-transitory computer-readable medium that may be used to store instructions and data which when executed by the processor 1104 cause performing computer-implemented methods to execute the techniques herein.

The instructions in memory 1106, ROM 1108 or storage 1110 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 1100 may be coupled via I/O subsystem 1102 to at least one output device 1112. In one embodiment, output device 1112 is a digital computer display. Examples of a display that may be used in various embodiments include a touch screen display or a light-emitting diode (LED) display or a liquid crystal display (LCD) or an e-paper display. Computer system 1100 may include other type(s) of output devices 1112, alternatively or in addition to a display device. Examples of other output devices 1112 include printers, ticket printers, plotters, projectors, sound cards or video cards, speakers, buzzers or piezoelectric devices or other audible devices, lamps or LED or LCD indicators, haptic devices, actuators or servos.

At least one input device 1114 is coupled to I/O subsystem 1102 for communicating signals, data, command selections or gestures to processor 1104. Examples of input devices 1114 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1116, which may perform cursor control or other automated control functions such as navigation in a graphical interface on a display screen, alternatively or in addition to input functions. Control device 1116 may be a touchpad, a mouse, a trackball, or cursor direction keys for communicating direction information and command selections to processor 1104 and for controlling cursor movement on display 1112. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 1114 may include a combination of multiple different input devices, such as a video camera and a depth sensor.

In another embodiment, computer system 1100 may comprise an internet of things (IoT) device in which one or more of the output device 1112, input device 1114, and control device 1116 are omitted. Or, in such an embodiment, the input device 1114 may comprise one or more cameras, motion detectors, thermometers, microphones, seismic detectors, other sensors or detectors, measurement devices or encoders and the output device 1112 may comprise a special-purpose display such as a single-line LED or LCD display, one or more indicators, a display panel, a meter, a valve, a solenoid, an actuator or a servo.

When computer system 1100 is a mobile computing device, input device 1114 may comprise a global positioning system (GPS) receiver coupled to a GPS module that is capable of triangulating to a plurality of GPS satellites, determining and generating geo-location or position data such as latitude-longitude values for a geophysical location of the computer system 1100. Output device 1112 may include hardware, software, firmware and interfaces for generating position reporting packets, notifications, pulse or heartbeat signals, or other recurring data transmissions that specify a position of the computer system 1100, alone or in combination with other application-specific data, directed toward host 1124 or server 1130.

Computer system 1100 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 1100 in response to processor 1104 executing at least one sequence of at least one instruction contained in main memory 1106. Such instructions may be read into main memory 1106 from another storage medium, such as storage 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 1110. Volatile media includes dynamic memory, such as memory 1106. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1102. Transmission media can also take the form of acoustic or light waves, such as those generated during radio-wave and infra-red data communications.

Various forms of media may be involved in carrying at least one sequence of at least one instruction to processor 1104 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1100 can receive the data on the communication link and convert the data to a format that can be read by computer system 1100. For instance, a receiver such as a radio frequency antenna or an infrared detector can receive the data carried in a wireless or optical signal and appropriate circuitry can provide the data to I/O subsystem 1102 such as place the data on a bus. I/O subsystem 1102 carries the data to memory 1106, from which processor 1104 retrieves and executes the instructions. The instructions received by memory 1106 may optionally be stored on storage 1110 either before or after execution by processor 1104.

Computer system 1100 also includes a communication interface 1118 coupled to bus 1102. Communication interface 1118 provides a two-way data communication coupling to network link(s) 1120 that are directly or indirectly connected to at least one communication networks, such as a network 1122 or a public or private cloud on the Internet. For example, communication interface 1118 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1122 broadly represents a local area network (LAN), wide-area network (WAN), campus network, internetwork or any combination thereof. Communication interface 1118 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1118 sends and receives electrical, electromagnetic or optical signals over signal paths that carry digital data streams representing various types of information.

Network link 1120 typically provides electrical, electromagnetic, or optical data communication directly or through at least one network to other data devices, using, for example, satellite, cellular, Wi-Fi, or BLUETOOTH technology. For example, network link 1120 may provide a connection through a network 1122 to a host computer 1124.

Furthermore, network link 1120 may provide a connection through network 1122 or to other computing devices via internetworking devices and/or computers that are operated by an Internet Service Provider (ISP) 1126. ISP 1126 provides data communication services through a world-wide packet data communication network represented as internet 1128. A server computer 1130 may be coupled to internet 1128. Server 1130 broadly represents any computer, data center, virtual machine or virtual computing instance with or without a hypervisor, or computer executing a containerized program system such as DOCKER or KUBERNETES. Server 1130 may represent an electronic digital service that is implemented using more than one computer or instance and that is accessed and used by transmitting web services requests, uniform resource locator (URL) strings with parameters in HTTP payloads, API calls, app services calls, or other service calls. Computer system 1100 and server 1130 may form elements of a distributed computing system that includes other computers, a processing cluster, server farm or other organization of computers that cooperate to perform tasks or execute applications or services. Server 1130 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 1130 may comprise a web application server that hosts a presentation layer, application layer and data storage layer such as a relational database system using structured query language (SQL) or no SQL, an object store, a graph database, a flat file system or other data storage.

Computer system 1100 can send messages and receive data and instructions, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage 1110, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 1104. While each processor 1104 or core of the processor executes a single task at a time, computer system 1100 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DBaaS provider manages or controls the underlying cloud infrastructure, applications, and servers, including one or more database servers.

7. Other Aspects of Disclosure

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including”, “includes”, “comprising”, “comprises”, “comprised” and the like) are intended to be inclusive and are not intended to exclude further features, components, integers or steps.

Various operations have been described using flowcharts. In certain cases, the functionality/processing of a given flowchart step may be performed in different ways to that described and/or by different systems or system modules. Furthermore, in some cases a given operation depicted by a flowchart may be divided into multiple operations and/or multiple flowchart operations may be combined into a single operation. Furthermore, in certain cases the order of operations as depicted in a flowchart and described may be able to be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

What is claimed is:

1. A computer-implemented method facilitating contactless delivery of a tangible good by a delivering party to an ordering party, the method performed at a server computing system comprising one or more processors and storage media storing instructions configured to perform the method, the instructions executed by the one or more processors to perform the method, the method comprising:
receiving scanning data from a first computing device associated with the delivering party, the scanning data comprising a digital image of a vehicle license plate of a target device of the ordering party;
using a first trained machine learning model, determining a vehicle registration plate number of the vehicle license plate of the target device in the digital image;
identifying a user account identification value associated in a datastore with the vehicle registration plate number;
based on the identified user account identification value, determining an order of the tangible good associated in a datastore with the user account identification value and transmitting order information about the order including an identifier of the tangible good to the first computing device, thereby causing a display of the order information in a graphical user interface at the first computing device;
transmitting a verification request to a second computing device, the second computing device associated in a datastore with the user account identification value, the verification request causing a display of a graphical user interface prompt at the second computing device to accept communications from the delivering party;
based on receiving an affirmative response to the verification request from the second computing device, forwarding a message received from the first computing device to the second computing device, the message pertaining to effectuating contactless delivery by the delivering party of the tangible good to the ordering party.

2. The computer-implemented method of claim 1, further comprising:
storing, in a datastore, target device data associated with the user account identification value comprising one or more digital images of the target device of the ordering party;
extracting a first set of one or more features from the target device data;
extracting a second set of one or more features from the scanning data;
determining that the first set of one or more features extracted from the target device data matches the second set of one or more features extracted from the scanning data to a certain threshold and in response, transmitting the verification request to the second computing device.

3. The computer-implemented method of claim 2, further comprising:
determining that the first set of one or more features extracted from the target device data does not match the second set of one or more features extracted from the scanning data to a certain threshold and in response, transmitting an alert to the second computing device or target device that requests further verification.

4. The computer-implemented method of claim 2, wherein:
the first set of one or more features comprises at least one: a color, a make, a model, a type, a region, and a type of defect; and
the second set of one or more features comprises at least one: a color, a make, a model, a type, a region, and a type of defect.

5. The computer-implemented method of claim 2, further comprising:
creating a training dataset comprising a plurality of digital images and a plurality of features that correspond to the plurality of digital images.
training a second machine learning model using the training dataset thereby generating a second trained machine learning model, the second trained machine learning model trained to extract: the first set of one or more features from the target device data and the second set of one or more features from the scanning data.

6. The computer-implemented method of claim 1, further comprising:
based on receiving a negative response to the verification request from the second computing device, restricting a transmission of messages between the first computing device and second computing device.

7. The computer-implemented method of claim 1, wherein the message requests the ordering party to open a compartment of the target device.

8. The computer-implemented method of claim 1, wherein the message comprises a command that, when received by the first computing device, causes enabling a particular graphical user interface (GUI) on the first computing device, the particular GUI on the first computing device configured to receive text or voice as an input and facilitate the creation of messages based on the input to be passed forwarded to the second computing device.

9. The computer-implemented method of claim 1, further comprising:
based on receiving an affirmative response to the verification request from the second computing device, forwarding a command received from the first computing device to the second computing device or the target device, the command indicating an action to be executed by the target device;
wherein the command, when received by the second computing device or the target device, causes an action to be executed by the target device.

10. The computer-implemented method of claim 9, wherein the action to be executed by the target device comprises at least of one:
opening a compartment that is associated with the target device, and
unlocking a compartment that is associated with the target device.

11. A computer system comprising:
one or more processors;
one or more memories storing instructions which, when executed by the one or more processors, cause the one or more processors to perform:
receiving scanning data from a first computing device associated with the delivering party, the scanning data comprising a digital image of a vehicle license plate of a target device of the ordering party;
using a first trained machine learning model, determining a vehicle registration plate number of the vehicle license plate of the target device in the digital image;
identifying a user account identification value associated in a datastore with the vehicle registration plate number;
based on the identified user account identification value, determining an order of the tangible good associated in a datastore with the user account identification value and transmitting order information about the order including an identifier of the tangible good to the first computing device, thereby causing a display of the order information in a graphical user interface at the first computing device;
transmitting a verification request to a second computing device, the second computing device associated in a datastore with the user account identification value, the verification request causing a display of a graphical user interface prompt at the second computing device to accept communications from the delivering party;
based on receiving an affirmative response to the verification request from the second computing device, forwarding a message received from the first computing device to the second computing device, the message pertaining to effectuating contactless delivery by the delivering party of the tangible good to the ordering party.

12. The computer system of claim 11, further comprising:
storing, in a datastore, target device data associated with the user account identification value comprising one or more digital images of the target device of the ordering party;
extracting a first set of one or more features from the target device data;
extracting a second set of one or more features from the scanning data;
determining that the first set of one or more features extracted from the target device data matches the second set of one or more features extracted from the scanning data to a certain threshold and in response, transmitting the verification request to the second computing device.

13. The computer system of claim 12, further comprising:
determining that the first set of one or more features extracted from the target device data does not match the second set of one or more features extracted from the scanning data to a certain threshold and in response, transmitting an alert to the second computing device or target device that requests further verification.

14. The computer system of claim 12, wherein:
the first set of one or more features comprises at least one: a color, a make, a model, a type, a region, and a type of defect; and
the second set of one or more features comprises at least one: a color, a make, a model, a type, a region, and a type of defect.

15. The computer system of claim 12, further comprising:
creating a training dataset comprising a plurality of digital images and a plurality of features that correspond to the plurality of digital images.
training a second machine learning model using the training dataset thereby generating a second trained machine learning model, the second trained machine learning model trained to extract: the first set of one or more features from the target device data and the second set of one or more features from the scanning data.

16. The computer system of claim 11, further comprising:
based on receiving a negative response to the verification request from the second computing device, restricting a transmission of messages between the first computing device and second computing device.

17. The computer system of claim 11, wherein the message requests the ordering party to open a compartment of the target device.

18. The computer system of claim 11, wherein the message comprises a command that, when received by the first computing device, causes enabling a particular graphical user interface (GUI) on the first computing device, the particular GUI on the first computing device configured to receive text or voice as an input and facilitate the creation of messages based on the input to be passed forwarded to the second computing device.

19. The computer system of claim 11, further comprising:
based on receiving an affirmative response to the verification request from the second computing device, forwarding a command received from the first computing device to the second computing device or the target device, the command indicating an action to be executed by the target device;
wherein the command, when received by the second computing device or the target device, causes an action to be executed by the target device.

20. The computer system of claim 19, wherein the action to be executed by the target device comprises at least of one:
opening a compartment that is associated with the target device, and
unlocking a compartment that is associated with the target device.
